(19) United States
(12) Patent Application Publication
(10) Pub. No.: US 2022/0276622 A1
(43) Pub. Date: Sep. 1, 2022

(54) PRECISE COORDINATION CONTROL SYSTEM AND METHOD FOR TWO MOTION STAGES

(71) Applicant: Harbin Institute of Technology, Harbin (CN)

(72) Inventors: Fazhi SONG, Harbin (CN); Yang LIU, Harbin (CN); Kaixin LIU, Harbin (CN); Xiaohui ZHANG, Harbin (CN)

(73) Assignee: Harbin Institute of Technology, Harbin (CN)

(21) Appl. No.: 17/681,870

(22) Filed: Feb. 28, 2022

(30) Foreign Application Priority Data
Mar. 1, 2021 (CN) 202110225803.7

(51) Int. Cl. G05B 13/04; G06F 30/20

(52) U.S. Cl. CPC G05B 13/042; G06F 30/20; G06F 2119/02

(57) ABSTRACT

A precise coordination control system includes a trajectory generator, a closed-loop system of a first motion stage, and a closed-loop system of a second motion stage. The precise coordination control method includes: initializing an iteration experiment count j to 1 and feedforward control signals of two motion stages to 0; performing the jth iteration experiment and running the coordination control system; updating the feedforward control signals of the two motion stages; and continuing next iteration and stopping the iteration experiment until a coordination motion error meets a precision requirement. Both of respective servo errors of two motion stages and the coordination motion error of the two motion stages can be reduced. A learning coefficient is designed by using an adaptive method to provide an increased convergence rate, high robustness to external random disturbances, and good anti-disturbance capability.

### CROSS-REFERENCE TO RELATED APPLICATIONS

This application claims priority to Chinese Patent Application No. 202110225803.7 with a filing date of Mar. 1, 2021. The content of the aforementioned application, including any intervening amendments thereto, is incorporated herein by reference.

### TECHNICAL FIELD

The present disclosure relates to a control system and method, in particular, to a precise coordination control system and method for two motion stages, and belongs to the field of ultra-precision equipment manufacturing.

### BACKGROUND ART

In the working process, ultra-precision equipment often needs a plurality of mechanisms coordinating with one another to meet the requirements of a complex process. In addition, high requirements may be imposed on coordination motion precision. Taking an immersion lithography machine that is being developed in China for example, to meet the requirements on imaging precision, a mask stage and a workpiece stage must move cooperatively in a scanning direction in a trajectory ratio of 4:1, and synchronization errors are required to meet strict requirements, i.e., moving average (MA)<0.5 nm and moving standard deviation (MSD)<5 nm.

The existing-node lithography machines use a control strategy “proportional-integral-derivative (PID) feedback plus acceleration feedforward” which, limited by mechanical bandwidths and model precision of motion stages, has been unable to meet such strict precision requirements. Accordingly, there is an urgent need for research and development of a new coordination control system and method. Several internationally renowned universities such as the University of California (USA), the Eindhoven University of Technology (Netherlands) and the Tsinghua University (China) introduced iterative learning control methods into the coordination motion of the mask stages and the workpiece stages of lithography machines in the scanning direction. However, existing methods usually can only improve the servo precision of a single motion stage or the coordination motion precision of two motion stages and cannot improve both the servo precision of a single motion stage and the coordination motion precision of two motion stages. Besides, such methods may have other problems, i.e., slow iterative processes, control precision being sensitive to external disturbances, and poor robustness, and thus are not suitable for practical engineering use.

### SUMMARY

To solve the problems of traditional coordination control systems and methods, i.e., failure to improve both the servo precision of a single motion stage and the coordination motion precision of two motion stages, slow iterative processes and poor robustness, the present disclosure provides a precise coordination control system and method for two motion stages. Compared with the traditional coordination control systems and methods, the precise coordination control system and method for two motion stages use an iterative learning method for coordination control, can improve not only the coordination motion precision of two motion stages but also the servo precision of a single motion stage, and are suitable for practical engineering use for a higher convergence rate and good anti-disturbance capability.

To achieve the above-mentioned objective, the present disclosure adopts the following technical solutions, a precise coordination control system for two motion stages includes a trajectory generator Cᵣ, a closed-loop system of a motion stage 1, and a closed-loop system of a motion stage 2, where the closed-loop system of the motion stage 1 includes a feedback controller C₁, a feedforward control signal e_{f1}, and a model P₁ of the motion stage 1; the closed-loop system of the motion stage 2 includes a feedback controller C₂, a feedforward control signal e_{f2}, and a model P₂ of the motion stage 2; the trajectory generator Cᵣ generates a desired motion trajectory y_{d1} of the motion stage 1 and a desired motion trajectory y_{d2} of the motion stage 2; the desired motion trajectory y_{d2} of the motion stage 2 and the desired motion trajectory y_{d1} of the motion stage 1 satisfy a relation y_{d2}=γy_{d1}, with γ being a scale coefficient; the closed-loop system of the motion stage 1 obtains a servo error e₁ of the motion stage 1 by subtracting an actual motion trajectory y₁ of the motion stage 1 from the desired motion trajectory y_{d1} of the motion stage 1, and the closed-loop system of the motion stage 2 obtains a servo error e₂ of the motion stage 2 by subtracting an actual motion trajectory y₂ of the motion stage 2 from the desired motion trajectory y_{d2} of the motion stage 2; the servo error e₁ of the motion stage 1 is combined with the feedforward control signal e_{f1} to provide a signal e_{c1}; the feedback controller C₁ generates a control signal u₁ from the signal e_{c1}; the control signal u₁ acts on the model P₁ of the motion stage 1 to obtain the actual motion trajectory y₁ of the motion stage 1; the servo error e₂ of the motion stage 2 is combined with the feedforward control signal e_{f2} to provide a signal e_{c2}; the feedback controller C₂ generates a control signal u₂ from the signal e_{c2}; the control signal u₂ acts on the model P₂ of the motion stage 2 to obtain the actual motion trajectory y₂ of the motion stage 2; and a coordination motion error is calculated by

$${e}_{s} = {y}_{1} - \frac{1}{γ} {y}_{2} .$$

A precise coordination control method for two motion stages includes the following steps:

step 1: initializing an iteration experiment count j to j=1 and both of the feedforward control signal e_{f1}^{j}(k) and the feedforward control signal e_{f2}^{j}(k) to 0, where the superscript j represents a current iteration count, while k=0, 1, 2, . . . , N−1 discrete sampling time, and N a sampling number;

step 2: performing the jth iteration, running the coordination control system to measure an actual motion trajectory y₁^{j}(k) of the motion stage 1 and the actual motion trajectory y₂^{j}(k) of the motion stage 2, respectively, and calculating the servo error e₁^{j}(k)=y_{d1}^{j}(k)−y₁^{j}(k) of the motion stage 1, the servo error e₂^{j}(k)=y_{d2}^{j}(k)−y₂^{j}(k) of the motion stage 2, and the coordination motion error

$${e}_{s}^{j} ( k ) = {y}_{1}^{j} ( k ) - \frac{1}{γ} {y}_{2}^{j} ( k ) ;$$

step 3: updating the feedforward control signal e_{f1} and the feedforward control signal e_{f2} as follows:

e_{f1}^{j+1}(k)=e_{f1}^{j}(k)+α^{j}T₂z^{β}e₁^{j}(k)

e_{f2}^{j+1}(k)=e_{f2}^{j}(k)+γα^{j}T₁z^{β}[e₁^{j}(k)+eₛ^{j}(k)]

where z is a time shift-forward operator, which, for any discrete signal x(k), satisfies z^{β}x(k)=x(k+β); T₁ is a discrete model of the closed-loop system of the motion stage 1 and T₂ is a discrete model of the closed-loop system of the motion stage 2, which satisfy

$${T}_{1} = \frac{{P}_{1} {C}_{1}}{1 + {P}_{1} {C}_{1}} and {T}_{2} = \frac{{P}_{2} {C}_{2}}{1 + {P}_{2} {C}_{2}} ;$$

α^{j} is a learning coefficient,
and β is a phase advance coefficient; and

step 4: incrementing the iteration count j by 1, returning to step 2 until the coordination motion error eₛ^{j}(k) meets a precision requirement, or stopping the iteration experiment when the iteration count j reaches a maximum allowable value.

Compared with the prior art, the present disclosure has the following beneficial effects: a traditional coordination control system and method may be directed to learn either a servo error of a single motion stage or a coordination motion error of two motion stages, cannot reduce both of respective servo errors of two motion stages and the coordination motion error of the two motion stages, and may be slow in learning convergence process and poor in robustness. The present disclosure allows for reduction in both of respective servo errors of two motion stages and the coordination motion error of the two motion stages, uses a learning coefficient which is designed by using an adaptive method to provide an increased convergence rate, high robustness to external random disturbances, and good anti-disturbance capability, and thus is suitable for practical engineering use.

### BRIEF DESCRIPTION OF THE DRAWINGS

FIG. 1 is a schematic diagram of a precise coordination control system for two motion stages according to the present disclosure.

FIG. 2 illustrates a desired motion trajectory of a motion stage 1 in simulation according to an example.

FIG. 3 is a diagram illustrating comparison of coordination motion errors in simulation according to an example.

FIG. 4 is a diagram illustrating comparison of iterative processes of coordination motion error norms in simulation according to an example.

FIG. 5 is a diagram illustrating comparison of servo errors of the motion stage 1 in simulation according to an example.

FIG. 6 is a diagram illustrating comparison of servo error norms of the motion stage 1 in simulation according to an example.

FIG. 7 is a diagram illustrating comparison of servo errors of a motion stage 2 in simulation according to an example.

FIG. 8 is a diagram illustrating comparison of iterative processes of servo error norms of the motion stage 2 in simulation according to an example.

### DETAILED DESCRIPTION OF THE EMBODIMENTS

The technical solutions in embodiments of the present disclosure will be described below clearly and completely. Apparently, the described embodiments are merely some rather than all of the embodiments of the present disclosure. All other embodiments derived from the embodiments of the present disclosure by a person of ordinary skill in the art without creative efforts should fall within the protection scope of the present disclosure.

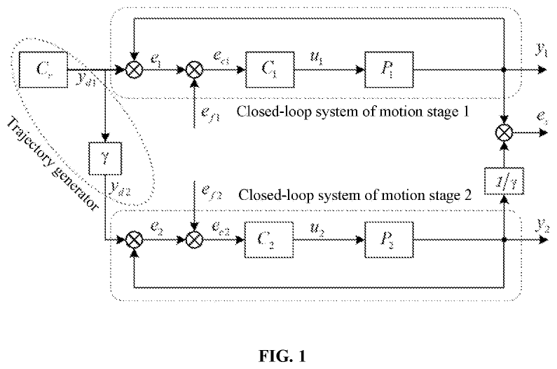

A precise coordination control system for two motion stages, as shown in FIG. 1, includes a trajectory generator Cᵣ, a closed-loop system of a motion stage 1, and a closed-loop system of a motion stage 2.

The closed-loop system of the motion stage 1 includes a feedback controller C₁, a feedforward control signal e_{f1}, and a model P₁ of the motion stage 1. The closed-loop system of the motion stage 2 includes a feedback controller C₂, a feedforward control signal e_{f2}, and a model P₂ of the motion stage 2.

The model P₁ of the motion stage 1 is obtained by modeling an actuator, a driven object and a measuring sensor of the motion stage 1, and the model P₂ of the motion stage 2 is obtained by modeling an actuator, a driven object and a measuring sensor of the motion stage 2. Each of the feedback controller C₁ and the feedback controller C₂ may be formed by proportional-integral-derivative (PID) elements cascaded with a low pass filter, and may also be formed by proportional-integral (PI) elements cascaded with a first-order advance controller.

The trajectory generator Cᵣ generates a desired motion trajectory y_{d1} of the motion stage 1 and a desired motion trajectory y_{d2} of the motion stage 2. The desired motion trajectory y_{d2} of the motion stage 2 and the desired motion trajectory y_{d1} of the motion stage 1 have a particular linear relation and satisfy the relation y_{d2}=γy_{d1}, with γ being a scale coefficient.

The closed-loop system of the motion stage 1 obtains a servo error e₁ of the motion stage 1 by subtracting an actual motion trajectory y₁ of the motion stage 1 from the desired motion trajectory y_{d1} of the motion stage 1, and the closed-loop system of the motion stage 2 obtains a servo error e₂ of the motion stage 2 by subtracting an actual motion trajectory y₂ of the motion stage 2 from the desired motion trajectory y_{d2} of the motion stage 2.

The servo error e₁ of the motion stage 1 is combined with the feedforward control signal e_{f1} to provide a signal e_{c1}. The feedback controller C₁ generates a control signal u₁ from the signal e_{c1}. The control signal u₁ acts on the model P₁ of the motion stage 1 to obtain the actual motion trajectory y₁ of the motion stage 1. The servo error e₂ of the motion stage 2 is combined with the feedforward control signal e_{f2} to provide a signal e_{c2}. The feedback controller C₂ generates a control signal u₂ from the signal e_{c2}. The control signal u₂ acts on the model P₂ of the motion stage 2 to obtain the actual motion trajectory y₂ of the motion stage 2.

A coordination motion error eₛ is calculated by subtracting

$$\frac{1}{γ}$$

of the actual motion trajectory y₂ of the motion stage 2 from the actual motion trajectory y₁ of the motion stage 1, i.e.,

$${e}_{s} = {y}_{1} - \frac{1}{γ} {y}_{2} .$$

A precise coordination control method for two motion stages, which can gradually reduce a coordination motion error by using an iterative learning method, includes the following steps:

step 1: initialize an iteration experiment count j to j=1 and both of the feedforward control signal e_{f1}^{j}(k) and the feedforward control signal e_{f2}^{j}(k) to 0, wherein the superscript j represents a current iteration count, while k=0, 1, 2, . . . , N−1 discrete sampling time, and N a sampling number;

step 2: perform the jth iteration experiment, run the coordination control system to measure an actual motion trajectory y₁^{j}(k) of the motion stage 1 and the actual motion trajectory y₂^{j}(k) of the motion stage 2, respectively, and calculate the servo error e₁^{j}(k)=y_{d1}^{j}(k)−y₁^{j}(k) of the motion stage 1, the servo error e₂^{j}(k)=y_{d2}^{j}(k)−y₂^{j}(k) of the motion stage 2, and the coordination motion error

$${e}_{s}^{j} ( k ) = {y}_{1}^{j} ( k ) - \frac{1}{γ} {y}_{2}^{j} ( k ) ;$$

step 3: update the feedfoward control signal e_{f1} and the feedforward control signal e_{f2} as follows:

e_{f1}^{j+1}(k)=e_{f1}^{j}(k)+α^{j}T₂z^{β}e₁^{j}(k)

e_{f2}^{j+1}(k)=e_{f2}^{j}(k)+γα^{j}T₁z^{β}[e₁^{j}(k)+eₛ^{j}(k)]

wherein z is a time shift-forward operator, which, for any discrete signal x(k), satisfies z^{β}x(k)=x(k+β); T₁ is a discrete model of the closed-loop system of the motion stage 1 and T₂ is a discrete model of the closed-loop system of the motion stage 2, which satisfy

$${T}_{1} = \frac{{P}_{1} {C}_{1}}{1 + {P}_{1} {C}_{1}} and {T}_{2} = \frac{{P}_{2} {C}_{2}}{1 + {P}_{2} {C}_{2}} ;$$

α^{j} is a learning coefficient, and β is a phase advance coefficient;

in this step, design the learning coefficient α^{j} by using an adaptive method and update the learning coefficient according to the following formula:

$${α}^{j} = \{ \begin{matrix}1 , & j = 1 \\ {α}^{j - 1} + {1}_{[ {( {E}_{s}^{j} )}^{T} {E}_{s}^{j - 1} < 0 ]} , & j \geq 2\end{matrix}$$

wherein

$${E}_{s}^{j} = {[ {e}_{s}^{j} ( 0 ) {{e}_{s}^{j} ( 1 )}_{s}^{j} ( 2 ) … {e}_{s}^{j} ( N - 1 ) ]}^{T} , and {1}_{[ {( {E}_{s}^{j} )}^{T} {E}_{s}^{j - 1} < 0 ]}$$

is a sign function; when

$${( {E}_{s}^{j} )}^{T} {E}_{s}^{j - 1} > 0 , {1}_{[ {( {E}_{s}^{j} )}^{T} {E}_{s}^{j - 1} < 0 ]} = 0 ;$$

and when

$${( {E}_{s}^{j} )}^{T} {E}_{s}^{j - 1} < 0 , {1}_{[ {( {E}_{s}^{j} )}^{T} {E}_{s}^{j - 1} < 0 ]} = 0 ;$$

and

determine the phase advance coefficient β according to the following formula:

$${max}_{β} \{ {w}_{0} : \vert θ ( w ) + β {T}_{s} w \vert < \frac{π}{2} - τ , ∀ w ∈ [ 0 , {w}_{0} ] \}$$

wherein Tₛ is a sampling period of the coordination control system, while w an angular frequency,

$$w ∈ [ 0 , \frac{1}{2 {T}_{s}} ] ,$$

θ(w) an phase angle of the discrete model G=T₁*T₂ at the angular frequency w, τ a phase margin (usually, τ=0⁰˜10⁰), and w₀ a maximum angular frequency satisfying

$$\vert θ ( w ) + β {T}_{s} w \vert < \frac{π}{2} - τ . ;$$

and β serves to correct the phase angle θ(w) of G such that the corrected θ(w)+βTₛw is in a range of

$$\pm ( \frac{π}{2} - τ )$$

within as wide band limits as possible; and

step 4: increment the iteration count j by 1, skip to step 2 until the coordination motion error eₛ^{j}(k) meets a precision requirement, or stop the iteration experiment when the iteration count j reaches a maximum allowable value.

### EXAMPLE

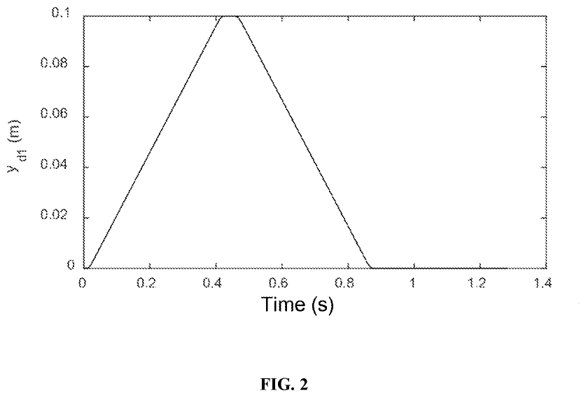

In this example, the trajectory generator Cᵣ is a 5-order S-shaped motion trajectory generator, and the generated desired motion trajectory y_{d1} of the motion stage 1 is as illustrated in FIG. 2. The desired motion trajectory y_{d2} of the motion stage 2 and the desired motion trajectory y_{d1} of the motion stage 1 satisfy the relation y_{d2}=γy_{d1}, with γ=4 in this example.

The feedback controller C₁ and the model P₁ of the motion stage 1 in the closed-loop system of the motion stage 1 are shown below:

$${C}_{1} = 1 {0}^{6} \times \frac{1.562 {z}^{2} - 3.092 z + 1.53}{{z}^{2} - 1.871 z + 0.871} {P}_{1} = 4.444 \times 1 {0}^{- 8} \times \frac{z + 1}{{z}^{2} - 2 z + 1}$$

The feedback controller C₂ and the model P₂ of the motion stage 2 in the closed-loop system of the motion stage 2 are shown below:

$${C}_{2} = 1 {0}^{6} \times \frac{1.567 {z}^{2} - 3.071 z + 1.504}{{z}^{2} - 1.746 z + 0.7457} {P}_{2} = 2 \times 1 {0}^{- 7} \times \frac{z + 1}{{z}^{2} - 2 z + 1}$$

With the sampling period Tₛ=200 μs of the coordination control system and the sampling number N=6414, the phase advance coefficient β=5 can be obtained according to the formula given in step 3. The maximum iteration count is set to 30 in this example.

To show the advantages of the present disclosure, in this example, simulation comparison is made with the coordination control system and method for two stages provided in Article “Iterative Learning Control in Synchronous Control System for Scan Lithography (Jiang Xiaoming, Yu Zhiliang, and Chen Xinglin; Proceedings of the World Congress on Intelligent Control and Automation (WCICA), 2014”. During simulation, to simulate the actual situation more accurately, while noise with a variance 2×10⁻⁸ is superimposed on the actual motion trajectories of the motion stage 1 and motion stage 2 as external disturbance to the coordination control system.

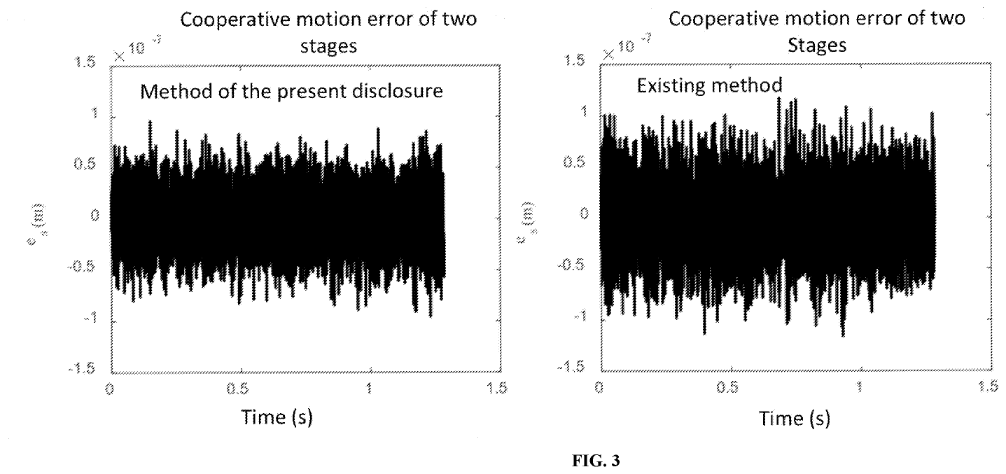

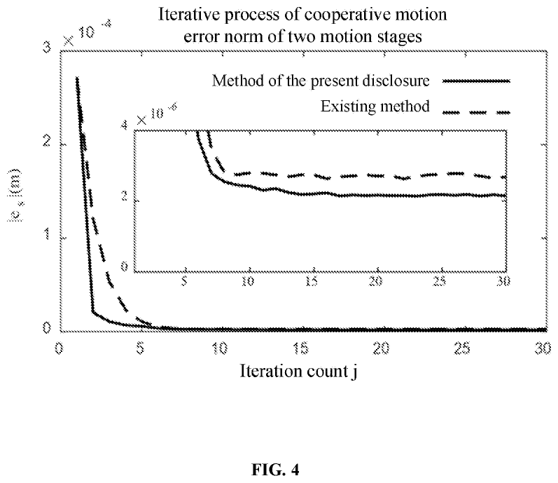

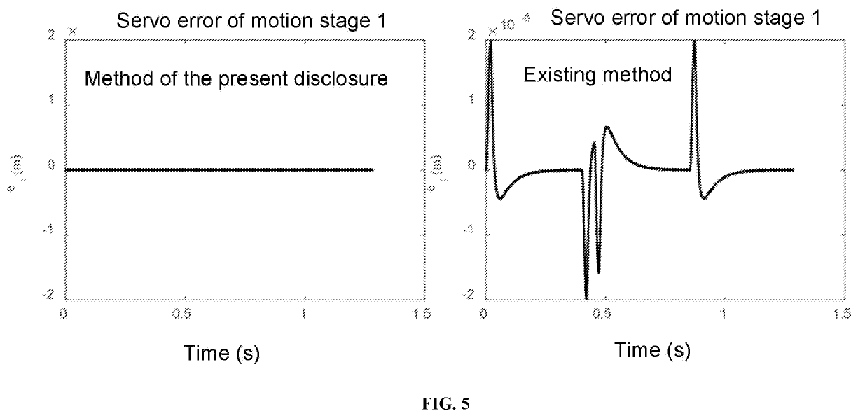

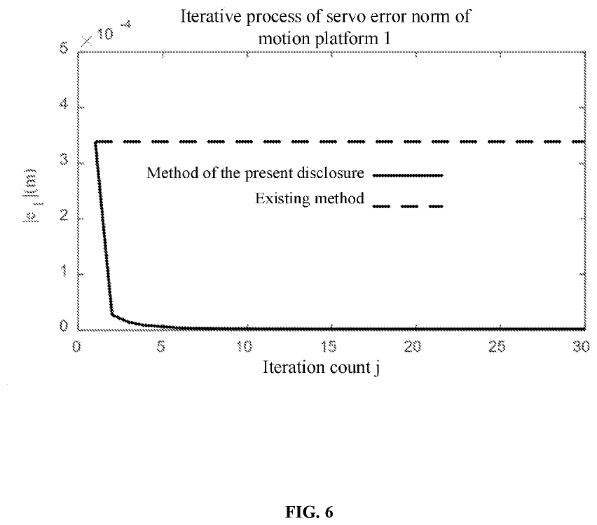

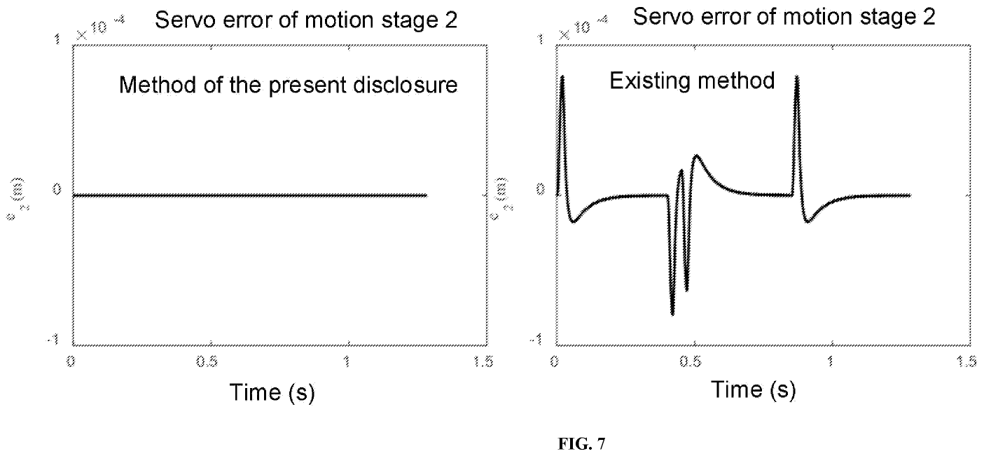

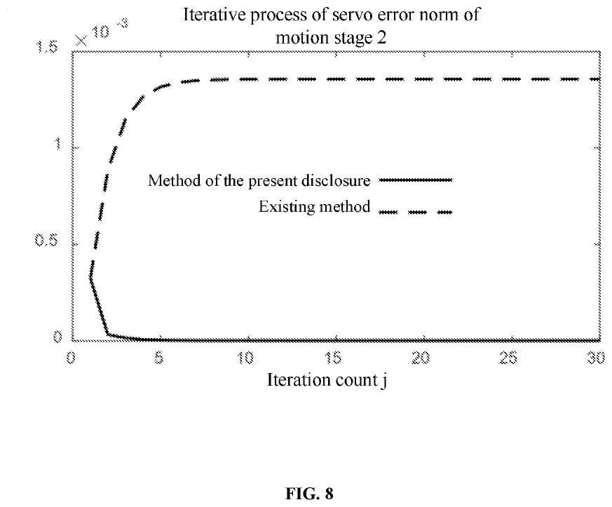

The results of comparison are shown in FIG. 3 to FIG. 8, among which FIG. 3, FIG. 5 and FIG. 7 show the comparison of respective errors after the last iteration experiment, and FIG. 4, FIG. 6 and FIG. 8 show changes of respective error norms with iterations.

FIG. 3 and FIG. 4 show the comparison of coordination motion errors of two stages. As can be seen, both of the method of the present disclosure and the existing method can reduce the coordination motion errors through iterations, and the method provided in the present disclosure is higher in convergence rate. Moreover, it can be seen that the coordination motion error in the method of the present disclosure may be smaller than that in the existing method at the same external disturbance level, indicating that the method of the present disclosure has higher robustness and better anti-disturbance capability. This is because the learning coefficient is designed by using the adaptive method in the present disclosure.

FIG. 5 and FIG. 6 show the comparison on the servo error of the motion stage 1. It can be seen that the servo error of the motion stage 1 is reduced gradually with increasing iterations while the servo error of the motion stage 1 in the existing method remains unchanged. This may result from that the closed-loop system of the motion stage 1 lacks the feedforward control signal e_{f1}.

FIG. 7 and FIG. 8 show the comparison on the servo error of the motion stage 2. It can be seen that the servo error of the motion stage 2 is reduced gradually with increasing iterations while the servo error of the motion stage 2 in the existing method increases continuously. This may result from that in view of unchanged servo error of the motion stage 1, to realize the coordination motion of two motion stages, the existing method is compelled to change the error of the motion stage 2 to realize synchronization with the motion stage 1.

From the results shown in FIG. 3 to FIG. 8, it can be seen that compared with the existing method, the method of the present disclosure can reduce both of the coordination motion error of two motion stages and the servo error of a single motion stage and have high convergence rate and good in robustness, and thus can achieve higher coordination motion precision.

It is apparent for those skilled in the art that the present disclosure is not limited to details of the above exemplary embodiments, and that the present disclosure may be implemented in other particular forms without departing from the spirit or basic features of the present disclosure. The embodiments should be regarded as exemplary and non-limiting in every respect, and the scope of the present disclosure is defined by the appended claims rather than the above descriptions. Therefore, all changes falling within the meaning and scope of equivalent elements of the claims are intended to be included in the present disclosure. Any reference numerals in the claims should not be considered as limiting the claims involved.

It should be understood that although this description is made in accordance with the embodiments, not every embodiment includes only one independent technical solution. Such a description is merely for the sake of clarity, and those skilled in the art should take the description as a whole. The technical solutions in the embodiments can also be appropriately combined to form other embodiments which are comprehensible for those skilled in the art.

What is claimed is:

1. A precise coordination control system for two motion stages, comprising a trajectory generator Cᵣ, a closed-loop system of a first motion stage, and a closed-loop system of a second motion stage, wherein the closed-loop system of the first motion stage comprises a feedback controller C₁, a feedforward control signal e_{f1}, and a model P₁ of the first motion stage; the closed-loop system of the second motion stage comprises a feedback controller C₂, a feedforward control signal e_{f2}, and a model P₂ of the second motion stage; the trajectory generator Cᵣ generates a desired motion trajectory y_{d1} of the first motion stage and a desired motion trajectory y_{d2} of the second motion stage; the desired motion trajectory y_{d2} of the second motion stage and the desired motion trajectory y_{d1} of the first motion stage satisfy a relation y_{d2}=γy_{d1}, with γ being a scale coefficient; the closed-loop system of the first motion stage obtains a servo error e₁ of the first motion stage by subtracting an actual motion trajectory y₁ of the first motion stage from the desired motion trajectory y_{d1} of the first motion stage, and the closed-loop system of the second motion stage obtains a servo error e₂ of the second motion stage by subtracting an actual motion trajectory y₂ of the second motion stage from the desired motion trajectory y_{d2} of the second motion stage; the servo error e₁ of the first motion stage is combined with the feedforward control signal e_{f1} to provide a signal e_{c1}; the feedback controller C₁ generates a control signal u₁ according to the signal e_{c1}; the control signal u₁ acts on the model P₁ of the first motion stage to obtain the actual motion trajectory y₁ of the first motion stage; the servo error e₂ of the second motion stage is combined with the feedforward control signal e_{f2} to provide a signal e_{c2}; the feedback controller C₂ generates a control signal u₂ according to the signal e_{c2}; the control signal u₂ acts on the model P₂ of the second motion stage to obtain the actual motion trajectory y₂ of the second motion stage; and a coordination motion error eₛ is calculated as follows:
$${e}_{s} = {y}_{1} - \frac{1}{γ} {y}_{2} .$$

2. The control system according to claim 1, wherein the model P₁ of the first motion stage is obtained by modeling an actuator, a driven object and a measuring sensor of the first motion stage, and the model P₂ of the second motion stage is obtained by modeling an actuator, a driven object and a measuring sensor of the second motion stage.

3. The control system according to claim 1, wherein each of the feedback controller C₁ and the feedback controller C₂ is formed by proportional-integral-derivative (PID) elements cascaded with a low pass filter or by proportional-integral (PI) elements cascaded with a first-order advance controller.

4. A control method of the precise coordination control system for two motion stages according to claim 1, comprising:
step 1: initializing a current iteration count j to j=1 and both of a first feedforward control signal e_{f1}^{j}(k) and a second feedforward control signal e_{f2}^{j}(k) to 0, wherein k is discrete sampling time and k=0, 1, 2, . . . , N−1, and N is a sampling number;
step 2: performing a jth iteration, running the coordination control system to measure an actual motion trajectory y₁^{j}(k) of a first motion stage and an actual motion trajectory y₂^{j}(k) of a second motion stage, respectively, and calculating a servo error e₁^{j}(k)=y_{d1}^{j}(k)−y₁^{j}(k) of the first motion stage, a servo error e₂^{j}(k)=y_{d2}^{j}(k)−y₂^{j}(k) of the second motion stage, and a coordination motion error
$${e}_{s}^{j} ( k ) = {y}_{1}^{j} ( k ) - \frac{1}{γ} {y}_{2}^{j} ( k ) ;$$
wherein y_{d1}^{j}(k) and y_{d2}^{j}(k) are desired motion trajectories of the first and second motion stages respectively;
step 3: updating the first feedforward control signal e_{f1} and the second feedforward control signal e_{f2} as follows:
e_{f1}^{j+1}(k)=e_{f1}^{j}(k)+α^{j}T₂z^{β}e₁^{j}(k)
e_{f2}^{j+1}(k)=e_{f2}^{j}(k)+γα^{j}T₁z^{β}[e₁^{j}(k)+eₛ^{j}(k)]
wherein z is a time shift-forward operator, which, for any discrete signal x(k), satisfies z^{β}x(k)=x(k+β); T₁ is a discrete model of the closed-loop system of the first motion stage and T₂ is a discrete model of the closed-loop system of the second motion stage, which satisfy
$${T}_{1} = \frac{{P}_{1} {C}_{1}}{1 + {P}_{1} {C}_{1}} and {T}_{2} = \frac{{P}_{2} {C}_{2}}{1 + {P}_{2} {C}_{2}} ;$$
α^{j} is a learning coefficient, and β is a phase advance coefficient; and
step 4: incrementing the iteration count j by 1, returning to step 2 until the coordination motion error eₛ^{j}(k) meets a precision requirement, or stopping the iteration when the iteration count j reaches a maximum allowable value.

5. The method according to claim 4, wherein the learning coefficient α^{j} is designed by using an adaptive method and updated according to the following formula:
$${α}^{j} = \{ \begin{matrix}1 , & j = 1 \\ {α}^{j - 1} + {1}_{[ {( {E}_{s}^{j} )}^{T} {E}_{s}^{j - 1} < 0 ]} , & j \geq 2\end{matrix}$$
wherein
$${E}_{s}^{j} = {[ {e}_{s}^{j} ( 0 ) {e}_{s}^{j} ( 1 ) {e}_{s}^{j} ( 2 ) … {e}_{s}^{j} ( N - 1 ) ]}^{T} , and {1}_{[ {( {E}_{s}^{j} )}^{T} {E}_{s}^{j - 1} < 0 ]}$$
is a sign
function; when
$${( {E}_{s}^{j} )}^{T} {E}_{s}^{j - 1} > 0 , {1}_{[ {( {E}_{s}^{j} )}^{T} {E}_{s}^{j - 1} < 0 ]} = 0 ;$$
and when
$${( {E}_{s}^{j} )}^{T} {E}_{s}^{j - 1} < 0 , {1}_{[ {( {E}_{s}^{j} )}^{T} {E}_{s}^{j - 1} < 0 ]} = 0.$$

6. The method according to claim 4, wherein the phase advance coefficient #3 in step 3 is determined according to the following formula:
$${max}_{β} \{ {w}_{0} : \vert θ ( w ) + β {T}_{s} w \vert < \frac{π}{2} - τ , ∀ w ∈ [ 0 , {w}_{0} ] \}$$
wherein Tₛ is a sampling period of the coordination control system, w is an angular frequency,
$$w ∈ [ 0 , \frac{1}{2 {T}_{s}} ] ,$$
θ(w) is an phase angle of a discrete model G=T₁*T₂ at the angular frequency w, τ a phase margin, and w₀ a maximum angular frequency satisfying
$$\vert θ ( w ) + β {T}_{s} w \vert < \frac{π}{2} - τ .$$

7. The method according to claim 6, wherein the phase margin is defined as τ=0⁰˜10⁰.
